(19) United States
(12) Patent Application Publication
(10) Pub. No.: US 2002/0014508 A1
(43) Pub. Date: Feb. 7, 2002

(54) System for aligning an edge of a moving web

(75) Inventor: Johannes Freermann, Ochtrup (DE)

Correspondence Address: THE FIRM OF KARL F ROSS, 5676 RIVERDALE AVENUE, PO BOX 900, RIVERDALE (BRONX), NY, 10471-0900, US

(73) Assignee: SCHMALE-HOLDING GmbH & CO.

(21) Appl. No.: 09/866,988

(22) Filed: May 29, 2001

(30) Foreign Application Priority Data
May 29, 2000 (DE) 10026426.3
Jul. 19, 2000 (DE) 10035021.6
Nov. 7, 2000 (DE) 10055139.4

(51) Int. Cl. B65H 43/08; B23Q 16/00

(52) U.S. Cl. 226/20; 226/17

(57) ABSTRACT

An apparatus for aligning a longitudinal edge of a flexible and continuously longitudinally moving web has a support having a longitudinally nondisplaceable face extending transversely across and immediately adjacent the edge and an alignment element having a plurality of parallel and elongated formations engageable with the web. An actuator displaces the element between an aligning position with the formations extending at an acute angle to the edge, pressing the web against the support face, and urging the moving web transversely outward at the edge and a standby position with the formations out of operative engagement with the web.

### FIELD OF THE INVENTION

The present invention relates to a system for aligning an edge of a moving web. More particularly this invention concerns such a system which straightens and positions an edge of a textile web.

### BACKGROUND OF THE INVENTION

In, for example, the assembly of textile products like pillow cases or blanket covers, it is necessary to take two fairly large textile workpieces and stitch them together along their edges. To this end the edges of the two workpiece panels must be fed precisely to the stitching station, one directly atop the other and with the edges positioned relative to the needle to produce the desired seam allowance, no more and no less.

Normally a roll or bolt of the web is set so that the edge of the web on the bolt is aligned properly, and the conveying system merely relies on keeping the web taut and flat to maintain the edge position. This does not work well with some knit fabrics which are fairly stretchy and pull in from the edges when freed from the bolt. Furthermore when conveyed over considerable distances the edges can migrate in or out no matter how carefully they are guided and fed.

### OBJECTS OF THE INVENTION

It is therefore an object of the present invention to provide an improved system for aligning the edge of a moving web.

Another object is the provision of such an improved system for aligning the edge of a moving web which overcomes the above-given disadvantages, that is which keeps the edge in position even when the web is transported over a considerable distance.

A further object is to provide an improved web-feeding system that allows the edges of two webs to be aligned perfectly with each other for feeding to a stitching machine.

### SUMMARY OF THE INVENTION

An apparatus for aligning a longitudinal edge of a flexible and continuously longitudinally moving web has according to the invention a support having a longitudinally nondisplaceable face extending transversely across and immediately adjacent the edge and an alignment element having a plurality of parallel and elongated formations engageable with the web. An actuator displaces the element between an aligning position with the formations extending at an acute angle to the edge, pressing the web against the support face, and urging the moving web transversely outward at the edge and a standby position with the formations out of operative engagement with the web.

The formations can be in continuous contact with the web and extend parallel to the edge in the standby position. In this case the element is pivotal about an axis generally perpendicular to the web to move the element between the positions. The actuator means are thus effective for pivoting of the element about the axis between its positions. Thus in this arrangement when the formations are out of “operative contact” with the web, they are still in actual physical contact with it but extend parallel to its displacement direction so they do not deflect it transversely.

Alternately the formations are out of contact with the web in the standby position and the element is displaceable generally perpendicular to the web. The actuator is effective to displace the element generally perpendicular to the web to move the element between the positions. With the latter system the support face is smooth and substantially planar and the formations of the element are a set of parallel ridges. It is also possible for the support to be a rotatable or nonrotatable roller or drum.

In another system the element is formed as a stack of transversely spaced plates. The support face is also has a plurality of parallel and elongated formations engageable with the web and interleavable with the formations of the element. The formations of both the support and element extend parallel to the edge in the standby position and are constantly interleaved. The element and support are fixed together for joint pivoting by the actuator about an axis generally perpendicular to the web to move the element between the positions jointly with the support. The plates of the element are in permanent mesh with the plates of the support and the support and element are limitedly movable toward and away from each other.

The apparatus according to the invention further has according to the invention a sensor fixed adjacent the support and adjacent a predetermined desired position of the web edge for detecting the web edge and emitting an output when it is in the desired position, and a controller connected to the actuator means for operating same to move the element into the alignment position and displace the web edge into the desired position when the sensor detects that the web edge is not in the desired position.

The alignment element can also have a surface engageable with the web that actually moves in a direction forming an acute angle with the displacement direction of the web. This movable surface can be formed by an endless belt, an array of endless belts, or an array of endless cables or wires that are advanced so that their reaches engaging the web are moving downstream at an oblique angle to the web transport direction.

In a system for seaming together a pair or webs at their edges the support has, in addition to the first-mentioned face, a second oppositely directed face. The apparatus further has according to the invention a second alignment element movable independently of the first-mentioned alignment unit, juxtaposed with the second face, and having a plurality of parallel and elongated formations engageable with the web. The second web runs between the second element and the second face. A second actuator displaces the second element between an aligning position with the respective formations extending at an acute angle to the edge, pressing the second web against the second support face, and urging the second web transversely outward at the edge and a standby position with the respective formations out of operative engagement with the second web. In this dual alignment-element system means is provided that is effective in the standby positions of the first and second elements for displacing the support out from between the webs.

### BRIEF DESCRIPTION OF THE DRAWING

The above and other objects, features, and advantages will become more readily apparent from the following description, reference being made to the accompanying drawing in which:

FIG. 1 is a side view of a system according to the invention in the standby position;

FIG. 2 is a view like FIG. 1 but with the system in the use or aligning position;

FIG. 2.1 is a top view of the system of FIG. 1;

FIG. 3 is a view like FIG. 1 but with the system returning from the use to the standby position;

FIG. 3.1 is a top view of the system of FIG. 3;

FIG. 4 is a view like FIG. 1 of another system in accordance with the invention;

FIG. 5 is a larger-scale top view of another system according to the invention; and

FIG. 6 is a view taken in the direction of arrow VI of FIG. 5.

### SPECIFIC DESCRIPTION

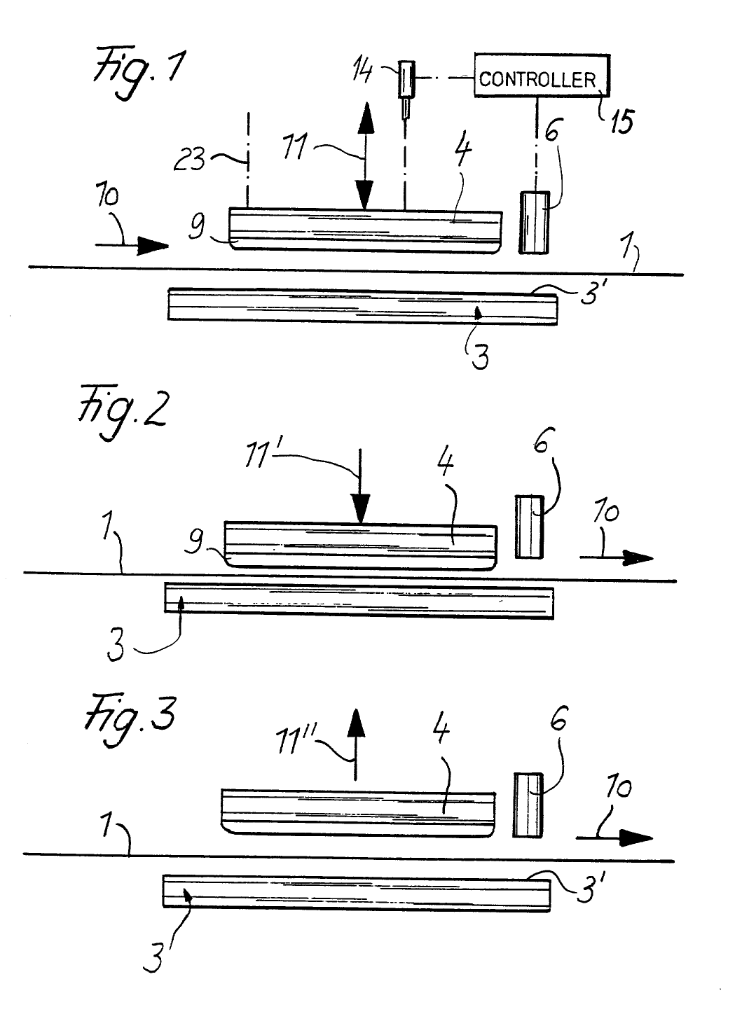

As seen in the FIGS. 1 through 3.1 a fabric web 1 according to the invention is conveyed in direction 10 in a horizontal plane by an unillustrated drive, for instance gripper rollers or belts, at a steady speed. It has two parallel longitudinal edges one of which is shown at 1′ and passes above and parallel to a smooth planar face 3′ of a generally stationary support plate 3. Above the support plate 3 is an alignment element or plate 4 having a planar lower face from which project a set of parallel formations or ridges 9 that normally extend at a small acute angle of about 30° to the direction 10. This plate 4 can be moved up and down in vertical direction 11 by means of an actuator 14 and/or can be pivoted about an axis 23 perpendicular to the directions 10 and 11 and to the plane of the web 1 by another actuator 24.

A common controller 15 of the microprocessor type is connected to both of the actuators 14 and 24 and to a stationary sensor 6 capable of detecting the presence or absence of the web 1 underneath itself. Normally the sensor 6 is of the light-beam type so that it only produces an output when its beam is not blocked by the web 1, that is when the edge 1′ is inward of it (up in FIGS. 2.1 and 3.1). Another actuator 25 connected to the controller 15 may be provided to displace the support plate 3 in a horizontal transverse direction 13 as described below with reference to FIG. 4. Normally two such systems sharing a common controller 15 are provided, one at each longitudinal edge of the web 1, and the sensors 6 are spaced apart transversely of the transport direction 10 by a distance equal to slightly less than the width W of the goods between its edges 1′.

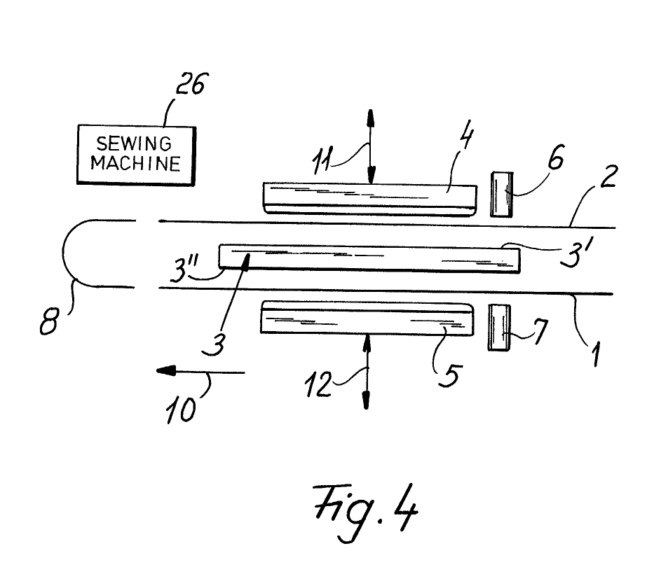

With this arrangement the alignment element 4 is normally in the FIG. 1 raised position and out of contact with the web 1, which also is out of contact with the face 3′, so long as the sensor 6 detects the web 1 riding in a position indicated at P. When, however, the edge 1′ moves inward to come out from underneath the sensor 6 and unblock its beam, the controller 14 operates the actuator 14 to press the plate 4 downward as indicated by arrow 11′ in FIG. 2. This action forces the web 1 down against the face 3′ and presses the angled ridges 9 into the web 1. Since the ridges 9 run from in to out in the direction 10, this has the effect of displacing the outer edge region outward (down in FIGS. 2.1 and 3.1) until the edge 1′ passes underneath the sensor 6 and blocks its beam, resuming position P. As soon as this desired position 8 is reached as shown in FIGS. 3 and 3.1 the actuator 14 raises the alignment element 4 in the direction 11″ to allow the web 1 to move freely between the support 3 and element 4, out of contact with both.

In FIG. 4 two such alignment elements 4 and 5 are used against opposite faces 3′ and 3″ of a common support plate 3. The lower plate 5 has its own sensor 7 connected to the controller 5 (FIG. 1). Respective webs 1 and 2 pass in the direction 10 between the plates 4 and 5 and the respective faces 3′ and 3″ and may be joined together upstream in the direction 8 at a loop 8. The support 3 can be a single plate or two separate plates each forming a respective one of the faces 3′ or 3″ and is movable by the actuator 25 horizontally.

Here the two alignment elements 4 and 5 are operated as above, but independently of each other to keep the respective workpiece edges in perfect vertical alignment so they can be stitched together at a following sewing machine illustrated schematically at 26. When the two edges are perfectly positioned, in fact, the actuator 25 can pull the support 3 out from between the two webs 1 and 2 to minimize wear and interference with their movement.

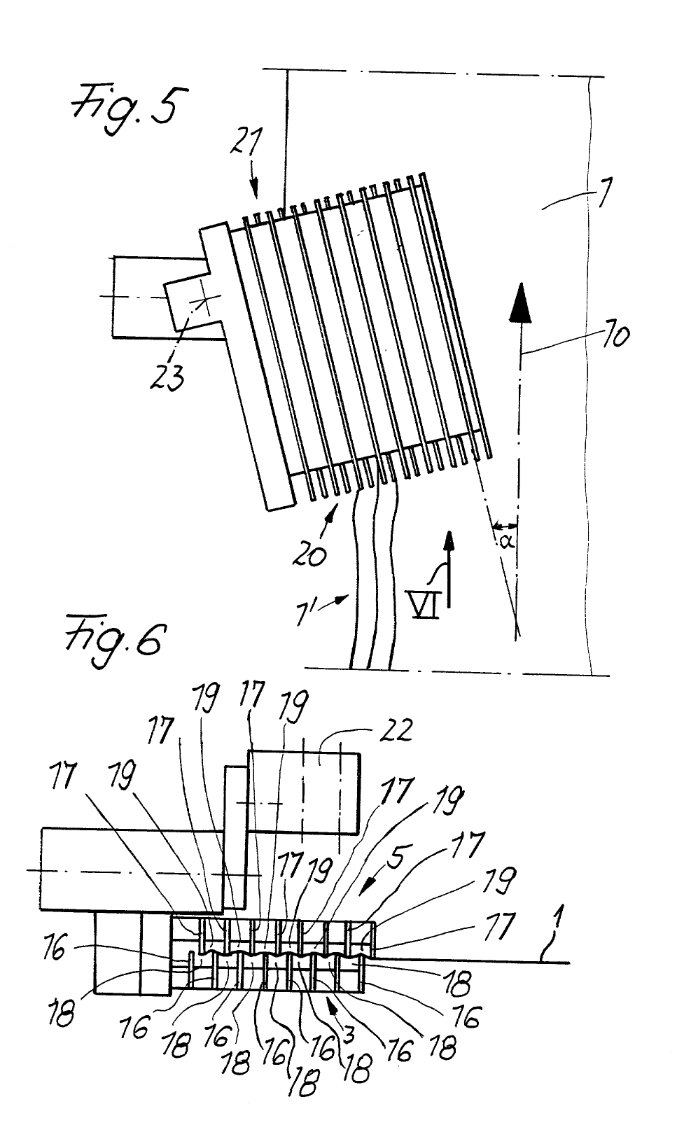

FIGS. 5 and 6 show another support 3 and alignment element 4 in more detail. They are similarly built, with the support 3 having a stack of identical plates 16 defining a row of upwardly open grooves 18 and the element 4 comprised of a set of parallel spaced plates 17 defining a row of downwardly open grooves 19. The plates 16 and 17 are identical, rigid, and of horizontally elongated rectangular shape. The plates 16 and 17 are staggered relative to each other so that the plates 16 engage in the grooves 19 and the plates 17 the grooves 18. The support 3 and element 4 are both carried on a common support 22, one being vertically displaceable thereon the vary the depth of interleave of the plates 16 and 17, that can be pivoted about the axis 23 by the actuator 24 shown in FIGS. 2.1 and 3.1. This changes an angle α that the plates 16 and 17 form with the direction 10.

This system is particularly suited for use with knit or jersey fabric that has a tendency to roll over at the edges. It is operated by the controller 14 and actuator 24 principally in a pivoting movement about the vertical axis 23. Thus when the edge 1′ is curled over or needs to be moved out, the angle A is somewhat acute as shown in FIG. 5, Thus as the web 1 passes from an intake side 20 to an output side 21 of the system, the edge 1′ is moved out to the desired position. When, however, the edge 1′ is in the desired position, the plates 16 and 17 are pivoted to an angle α of 0° so that they run parallel to the direction 10 and exert no transverse force on the web 1.

I claim:

1. An apparatus for aligning a longitudinal edge of a flexible and continuously longitudinally moving web, the apparatus comprising:
a support having a longitudinally nondisplaceable face extending transversely across and immediately adjacent the edge;
an alignment element having a plurality of parallel and elongated formations engageable with the web; and
actuator means for displacing the element between an aligning position with the formations extending at an acute angle to the edge, pressing the web against the support face, and urging the moving web transversely outward at the edge and a standby position with the formations out of operative engagement with the web.

2. The edge-aligning apparatus defined in claim 1 wherein the formations are in continuous contact with the web and extend parallel to the edge in the standby position, the element being pivotal about an axis generally perpendicular to the web to move the element between the positions, the actuator means being effective for pivoting of the element about the axis between its positions.

3. The edge-aligning apparatus defined in claim 1 wherein the formations are out of contact with the web in the standby position, the element being displaceable generally perpendicular to the web, the actuator means being effective to displace the element generally perpendicular to the web to move the element between the positions.

4. The edge-aligning apparatus defined in claim 1 wherein the support face is smooth and substantially planar.

5. The edge-aligning apparatus defined in claim 4 wherein the formations of the element are a set of parallel ridges.

6. The edge-aligning apparatus defined in claim 5 wherein the element is formed a s a stack of transversely spaced plates.

7. The edge-aligning apparatus defined in claim 1 wherein the support face is also has a plurality of parallel and elongated formations engageable with the web and interleavable with the formations of the element.

8. The edge-aligning apparatus defined in claim 7 wherein the formations of both the support and element extend parallel to the edge in the standby position, the formations of the support and element being constantly interleaved, the element and support being fixed together for joint pivoting by the actuator means about an axis generally perpendicular to the web to move the element between the positions jointly with the support.

9. The edge-aligning apparatus defined in claim 8 wherein the element and support are each formed as a stack of upright transversely spaced plates, the plates of the support being interleaved with the plates of the element.

10. The edge-aligning apparatus defined in claim 9 wherein the plates of the element are in permanent mesh with the plates of the support and the support and element are limitedly movable toward and away from each other.

11. The edge-aligning apparatus defined in claim 1, further comprising:
means including a sensor fixed adjacent the support and adjacent a predetermined desired position of the web edge for detecting the web edge and emitting an output when it is in the desired position; and
controller means connected to the actuator means for operating same to move the element into the alignment position and displace the web edge into the desired position when the sensor detects that the web edge is not in the desired position.

12. The edge-aligning apparatus defined in claim 1 wherein there is a second such web spaced vertically from the first-mentioned web and the support has, in addition to the first-mentioned face, a second oppositely directed face, the apparatus further comprising:
a second alignment element movable independently of the first-mentioned alignment unit, juxtaposed with the second face, and having a plurality of parallel and elongated formations engageable with the web, the second web running between the second element and the second face; and
second actuator means for displacing the second element between an aligning position with the respective formations extending at an acute angle to the edge, pressing the second web against the second support face, and urging the second web transversely outward at the edge and a standby position with the formations out of operative engagement with the second web.

13. The edge-aligning apparatus defined in claim 12, further comprising
means effective in the standby positions of the first and second elements for displacing the support out from between the webs.

14. An apparatus for aligning a longitudinal edge of a flexible and continuously longitudinally moving web, the apparatus comprising:
a support having a longitudinally nondisplaceable face extending transversely across and immediately adjacent the edge;
an alignment element having a plurality of parallel and elongated formations engageable with the web;
actuator means for displacing the element between an aligning position with the formations extending at an acute angle to the edge, pressing the web against the support face, and urging the moving web transversely outward at the edge and a standby position with the formations out of operative engagement with the web;
means including a sensor fixed adjacent the support and adjacent a predetermined desired position of the web edge for detecting the web edge emitting an output when it is in the desired position; and
controller means connected to the actuator means for operating same to move the element into the alignment position and displace the web edge into the desired position when the sensor detects that the web edge is not in the desired position.
